(19) United States
(12) Patent Application Publication
(10) Pub. No.: US 2009/0124233 A1
(43) Pub. Date: May 14, 2009

(54) Methods, Systems, And Computer Program Products For Controlling Data Transmission Based On Power Cost

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 11/937,813

(22) Filed: Nov. 9, 2007

(51) Int. Cl. H04M 11/00

(52) U.S. Cl. 455/406

(57) ABSTRACT

Methods, systems, and computer program products are disclosed for controlling data transmission based on power cost. A power cost per unit data associated with successfully sending data from a sending device to a receiving device in a communications network is determined. The determined power cost per unit data is compared to a first threshold. Transmission of data from the sending device to the receiving device is delayed based on a determination that the power cost per unit data exceeds the first threshold.

### RELATED APPLICATIONS

This application is related to U.S. Pat. No. 7,242,920, titled “Methods, Systems, and Computer Program Products for Controlling Data Transmission Based on Power Cost,” filed on May 31, 2005, and U.S. patent application Ser. No. 11/763,805, titled “Methods, Systems, and Computer Program Products for Controlling Data Transmission Based on Power Cost,” filed on Jun. 15, 2007 as a continuation of U.S. Pat. No. 7,242,920 (prior to issuance), the entire disclosures of which are incorporated by reference herein.

### BACKGROUND

Reducing power consumption in electronic devices is of growing concern. Devices today include an ever-growing list of features, such as Web browsing, e-mail, text messaging, and digital photography, to name a few. In the meantime, the cost of electrical power is rising. Manufacturers strive to make their electronic devices more energy efficient. For example, power is consumed by a device's transmitter whenever data is transmitted, such as when an e-mail, digital photograph, or text message is sent or when data is uploaded to a web site.

Moreover, the amount of power consumed will vary based on characteristics of the data transmission. For example, the same amount of data can be transmitted multiple times via a network to a destination under varying circumstances, with each time resulting in a different amount of power being consumed in connection with the data transmission, which is referred to herein as a power cost. It would be advantageous to control data transmission based on power cost to provide reduced power consumption.

Accordingly, there exists a need for methods, systems, and computer program products for controlling data transmission based on power cost.

### SUMMARY

According to an aspect of the subject matter disclosed herein, a method for controlling data transmission based on power cost includes determining a power cost per unit data associated with successfully sending data from a sending device to a receiving device in a communications network, comparing the power cost per unit data to a first threshold, and delaying transmission of data from the sending device to the receiving device based on a determination that the power cost per unit data exceeds the first threshold.

According to an aspect of the subject matter disclosed herein, a system for controlling data transmission based on power cost includes means for determining a power cost per unit data associated with successfully sending data from a sending device to a receiving device in a communications network, means for comparing the power cost per unit data to a first threshold, and means for delaying transmission of data from the sending device to the receiving device based on a determination that the power cost per unit data exceeds the first threshold.

According to an aspect of the subject matter disclosed herein, a system for controlling data transmission based on power cost includes a power cost monitor configured to determine a power cost per unit data associated with successfully sending data from a sending device to a receiving device in a communications network, and that compares the power cost per unit data to a first threshold, and a transmitter controller configured to delay transmission of data from the sending device to the receiving device based on a determination that the power cost per unit data exceeds the first threshold.

According to an aspect of the subject matter disclosed herein, a computer program product comprises computer executable instructions embodied in a computer-readable medium for performing steps including determining a power cost per unit data associated with successfully sending data from a sending device to a receiving device in a communications network, comparing the power cost per unit data to a first threshold, and delaying transmission of data from the sending device to the receiving device based on a determination that the power cost per unit data exceeds the first threshold.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a schematic diagram illustrating an arrangement in which the subject matter described herein may be applied;

FIG. 2 includes graphical representations illustrating power consumption, data rate, power cost, and data transmission of a sending device according to an aspect of the subject matter disclosed herein;

FIG. 3 is a block diagram illustrating a networked device with a system for controlling data transmission based on power cost according to an aspect of the subject matter disclosed herein;

FIG. 4 is a flow diagram illustrating a method for controlling data transmission based on power cost according to an aspect of the subject matter disclosed herein;

FIG. 5 is a flow diagram illustrating a method for controlling data transmission based on power cost according to another aspect of the subject matter disclosed herein;

FIG. 6 is a flow diagram illustrating a method for controlling data transmission based on power cost according to another aspect of the subject matter disclosed herein;

FIG. 7 is a flow diagram illustrating a method for controlling data transmission based on power cost according to another aspect of the subject matter disclosed herein; and

FIG. 8 is a flow diagram illustrating a method for controlling data transmission based on power cost according to another aspect of the subject matter disclosed herein.

### DETAILED DESCRIPTION

According to the subject matter described herein, power consumption is reduced by delaying data transmissions until the power cost per unit data is below a threshold value. For example, if a mobile phone user sends an e-mail to an e-mail recipient, the transmission of the e-mail may be delayed until a favorable power costs per unit data exists, as described further below. Consequently, power consumption is reduced in comparison to sending the e-mail without considering power cost.

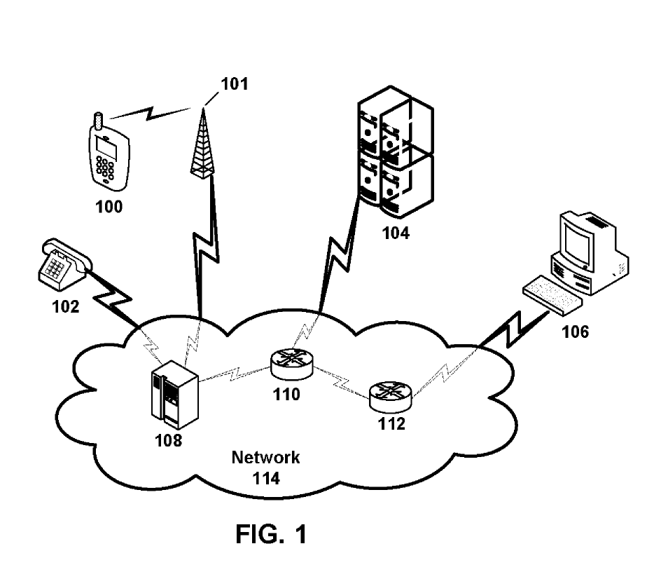

FIG. 1 is a schematic diagram illustrating a communication scenario in which the subject matter described herein may be applied. In FIG. 1, several exemplary communication devices are shown capable of communicating via a communications network 114. Among the exemplary communication devices are a mobile phone 100, a landline communication device 102 (such as a telephone, Internet phone, and the like), a server 104, and a personal computer 106. These communication devices are typically endpoint devices. That is, these communication devices typically initiate the sending of data and/or are terminal recipients of data that is sent via a network. The mobile phone 106 is shown communicating with the network 114 via a base station 101, in addition to other cellular network components (not shown), such as for example, a mobile switching center and/or a gateway. These omitted cellular network components are also communication devices for the purposes of this description. Other exemplary communication devices that are shown in FIG. 1 are a network gateway 108 and routers 110, 112. These devices are typically intermediate devices that typically receive data destined for a recipient communication device as an intermediate step to the delivery of the data to the recipient communication device. Other communication devices, both endpoint and intermediate, known to one of ordinary skill in this art are also contemplated within the subject matter described herein. For example, other exemplary communication devices include a printer, a fax, a remote display, a camera, a plotter, a bridge, a hub, a switch, a firewall, and a copier.

For the purposes of this description, any of the communication devices 100-112 illustrated in FIG. 1 can be a sending device or can be a receiving device. By way of example, however, an exemplary scenario will be described wherein the personal computer 106 is the sending device (and will be referred to as the sending device 106 hereinafter) and the server 104 is the receiving device (and will be referred to as the receiving device 104 hereinafter). As shown in FIG. 1, the sending device 106 is communicating with the receiving device 104 via the network 114. Network 114 can be a direct link, a local area network (LAN), a personal area network (PAN), an intranet, a wide area network (WAN) such as the Internet, and the like. Any type of network(s) can be used. For example, the network can include a wireless network portion, a wired network portion, or any combination thereof. In the current example, the sending device 106 and receiving device 104 are both endpoints of a data transmission over the network 114. Alternatively, however, one or both of the sending device and receiving device can be an intermediate device, such as the network gateway 108 or router 110, 112. For example, router 112 can be the sending device with respect to data sent to router 110 (or vice-versa) and/or with respect to data sent to server 104. Note that sending devices and receiving devices can reverse roles in the performance of the methods and systems described herein.

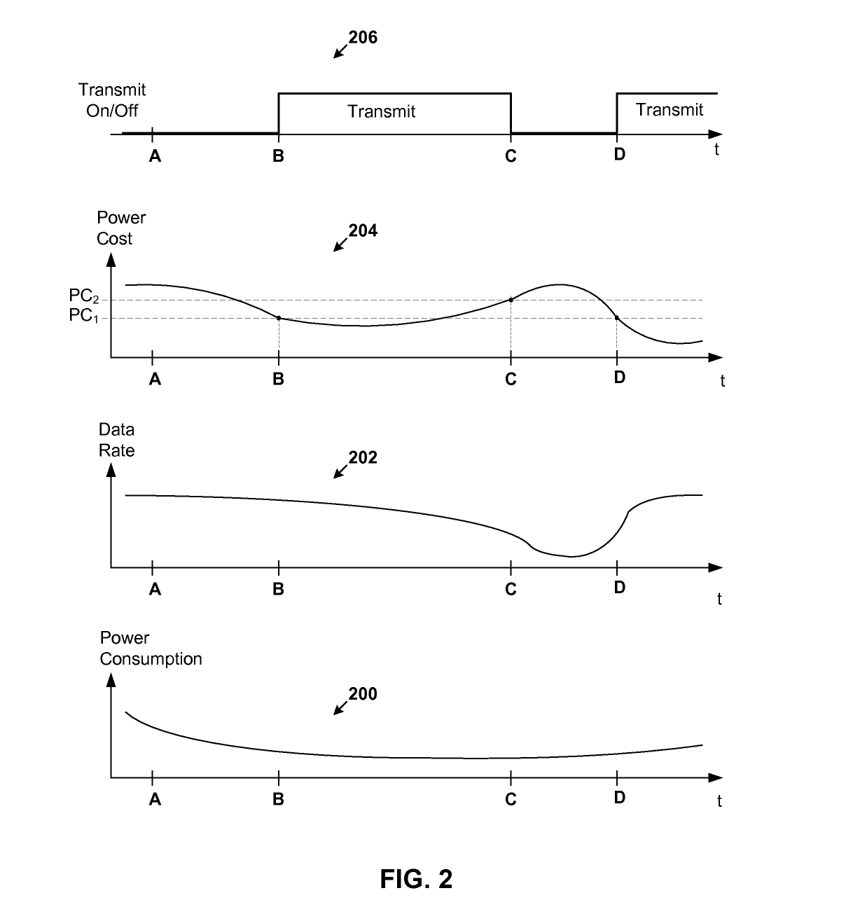

FIG. 2 includes graphical representations illustrating power consumption, data rate, power cost, and data transmission of sending device 106 at times A, B, C, and D according to an aspect of the subject matter disclosed herein. In FIG. 2, a power consumption graph 200 represents a power consumption rate associated with data transmission in sending device 106 as a function of time. The power consumption rate is an amount of power consumed in connection with the transmission of data from sending device 106. The power consumption rate may be determined in sending device 106 by measuring, estimating, or looking up a power consumption rate associated with the transmission of data by a transmitter and other components of sending device 106. For example, the power consumption rate will be higher at times that the transmitter is not already in an active (transmitting) state because it will include the power needed to first activate or “wake up” the transmitter from an inactive state. In contrast, if the transmitter is already sending other data, there is a lesser incremental power consumption increase resulting from sending the additional data. According to another aspect, another consideration in determining power consumption can be the utility/supplier charge for power incurred. In many cases, power is more expensive at peak times of usage. A power consumption determination can take that into account and be weighted higher when the utility charges are higher for power, such as during those when those peak times. In another aspect, another consideration in determining power consumption can be the associated with power level of power supplied by the utility. For example, during a lightning storm where power levels can drop several times in a specified time period, the power levels can be monitored as a power consumption factor. Other power consumption factors can be the amount of power required to transmit data wirelessly. For example, referring to FIG. 1, the mobile device 100 typically requires more power to transmit data as the distance to the base station 101 increases.

Returning to FIG. 2, a data rate graph 202 is shown that represents a data transmission rate for data transmitted by sending device 106 as a function of time. The data transmission rate may be associated with the rate of data successfully sent from a transmitter in sending device, to receiving device 104. The data transmission rate may be determined by considering data throughput, bit error rate (BER), a number of retries, network congestion, a number of collisions, a number of dropped packets, and other such data rate variables known in the art. The data transmission rate can be based on data transmission at any communication device along the path through network 114, such as through routers 110, 112, links in the network, or at other devices affecting communications through the network 114. The data transmission rate can be based on a transmission attribute of one or more of a link layer, a network layer, a transport layer, and/or any layer above the transport layer. The layers are defined in the Open System Interconnection (OSI) Reference Model. For example, transmission control protocol (TCP) is a transport layer protocol, and Internet protocol (IP) is a network layer protocol included in the TCP/IP protocol suite.

In an example, if 1 Mb of data is transmitted by a transmitter of sending device 106 during a 1 s time period and only 500 Kb of data are received at receiving device 104 due to dropped packets or other transmission errors, the data transmission rate for the given time period may be considered to be 500 Kb/s. The data transmission rate may be determined in whole or in part by feedback received from receiving device 104 and/or another network node in the network path between sending device 106 and receiving device 104.

A power cost graph 204 represents a power cost per unit data associated with sending data from sending device 106 as a function of time. The power cost per unit data may be determined by dividing the power consumption rate by the data rate. An exemplary power cost per unit data value may be (1.0 mW/s)/(500 Kb/s)=2.0×10⁻⁹ W/Kb. As will be appreciated, power cost per unit data may be determined using other calculations that may include weighting factors and/or other known parameters. Power cost graph 204 includes two power cost thresholds, PC₁ and PC₂. PC₁ represents a maximum power cost per unit data value below which data transmission is started. PC₂ is an optional second power cost threshold that represents a maximum power cost per unit data above which ongoing data transmission is halted. As will be appreciated, PC₂ may be set equal to PC₁ and/or additional thresholds may be employed.

Finally, a transmit on/off graph 206 illustrates periods during which data is transmitted (or is not transmitted) by sending device 106 as a function of time.

With reference to FIGS. 1 and 2, at time A, the data rate 202 is favorable but the power consumption is relatively high, which results in a power cost that is above PC₁ at time A. As discussed above, the high power consumption 200 can be, for example, because the communication device's transmitter is in currently inactive (“sleep mode”), which requires additional power overhead for transitioning the transmitter to an active (transmitting) mode. In another example, the charge incurred from a utility for power at this particular time may be high because, for example, it is during peak power demand times. Consequently, the power cost 204 is too high even though the data rate 202 is favorable and no data is transmitted at time A, as shown in graph 206.

At time B, the data rate 202 is still favorable and the power consumption 200 is reduced. The power consumption 200 can be lower, for example, because the communication device's transmitter is already in an active mode. The lower power consumption 200 results in a power cost reduction 204 such that the power cost per unit data is below PC₁ at time B. Consequently, data transmission is initiated at time B, as shown in graph 206.

At time C, power consumption 200 remains relatively low but the data rate 202 drops due to an increase in transmission error rate. The increase in transmission error rate may result, for example, from network congestion, dropped packets, collisions, and other error-causing conditions. Consequently, power cost 204 increases above PC₂ and data transmission is stopped at time C, as shown in graph 206.

At time D, power consumption 200 remains relatively low and the data rate 202 increases due to a reduction in the transmission error rate. Consequently, power cost 204 again decreases below PC₁ and data transmission is restarted at time D, as shown in graph 106.

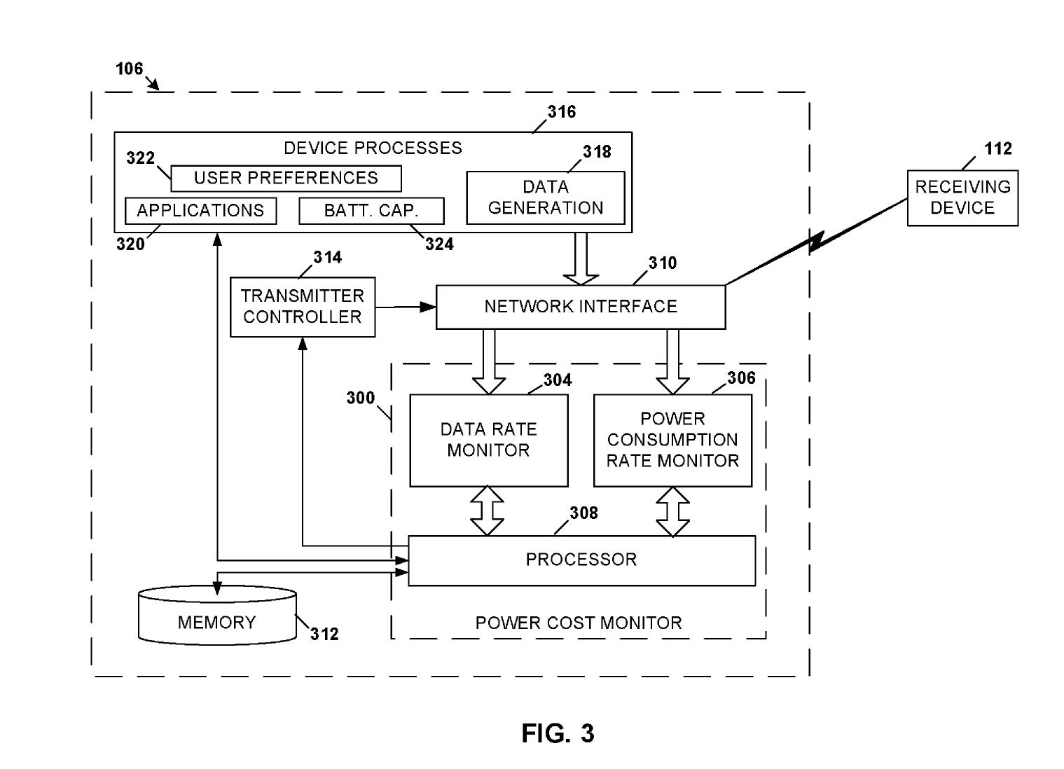

FIG. 3 is a block diagram illustrating sending device 106 with a system for controlling data transmission based on power cost according to an aspect of the subject matter disclosed herein. In FIG. 3, sending device 106 includes means for determining a power cost per unit data associated with successfully sending data from a sending device to a receiving device in a communications network. For example, sending device 106 may include a power cost monitor 300 that determines a power cost per unit data associated with successfully sending data from sending device 106 to receiving device 104 in a communications network. As discussed above, sending device 106 and receiving device 104 may be any networked device addressable by sending device 106, including any wireless and wired network entity known in the art.

Power cost monitor 300 includes a data rate monitor 304, a power consumption rate monitor 306, and a processor 308. Data rate monitor 304 determines a data transmission rate associated with successfully sending data from a network interface 310 of sending device 106 to receiving device 104. Network interface 310 can include a transmitter and/or receiver for sending/receiving data via network 114. For example, data rate monitor 304 may be configured to determine a data transmission rate associated with successfully sending data via network interface 310 to receiving device 104 by determining data throughput, BER, a number of retries, a number of dropped packets, and/or a number of collisions. Data rate monitor 304 may take any unsuccessful data transmissions into account. In one aspect, data rate monitor 304 is configured to determine a power consumption rate associated with data transmission by determining a measure of data throughput for successful data transmission to receiver 104. Data throughput feedback, for example, is received from receiving device 104 via network interface 310. Alternately, or in addition to receiving feedback from receiving device 104, feedback can be received via any network node in the network associated with sending at least a portion of the data transmitted by sending device 106 to receiving device 104. In yet another aspect, the data rate is determined by a combination of directly measuring throughput and any of the previously described techniques or by a combination of techniques. Note that a sending and/or a receiving device can communicate using a wireless network interface, such the network interface 310, and/or by using a wired network interface card (NIC), such as an Ethernet adapter (not shown).

Power consumption rate monitor 306 determines a power consumption rate associated with data transmission. As discussed above, the power consumption rate will be higher at times that the transmitter is not already in an active (transmitting) state because it will include the power needed to first activate or “wake up” the transmitter from an inactive state. In contrast, if the transmitter is already sending other data, there is a lesser incremental power consumption increase resulting from sending the additional data. According to one aspect, the power consumption rate monitor 306 determines a power consumption rate based on whether the transmitter is in an active or inactive mode.

According to another aspect, another consideration in determining power consumption can be the utility/supplier charge for power incurred. The power consumption rate monitor 306 determines a power consumption rate based on utility charges for power. In another aspect, power consumption rate monitor 306 is configured to determine a power consumption rate associated with data transmission by measuring a power consumption rate of a transmitter and any other components associated with the data transmission.

Processor 308 determines the power cost per unit data based on the determined data transmission rate measure and the determined power consumption rate received from data rate monitor 304 and power consumption rate monitor 306, respectively. For example, processor 308 may determine the power cost per unit data by dividing the power consumption rate by the data transmission rate measure, as discussed above, or using another calculation/algorithm.

Sending device 106 also includes means for comparing the power cost per unit data to one or more thresholds. For example, processor 308 can compare the power cost per unit data to one or more thresholds. The threshold can be static or can change dynamically. In one implementation, sending device 106 includes a memory 312 for storing one or more threshold values and processor 308 compares the power cost per unit data to a threshold by retrieving the threshold from memory 312 and comparing the power cost per unit data to the retrieved threshold. For example, processor 308 may retrieve a threshold from memory 312 by performing a lookup in a lookup table stored in memory 312.

Sending device 106 also includes means for delaying transmission of data from the sending device to the receiving device based on a determination that the power cost per unit data exceeds a threshold. For example, a transmitter controller 314 can delay transmission of data from the sending device 106 to the receiving device 104 based on a determination to processor 308 that the power cost per unit data exceeds the threshold. Here, the transmitter controller 314 may be configured to delay transmission of only non-real-time data. As used herein, non-real-time data refers to data that does not need to be transmitted in real-time or near-real-time in order to be usable for its primary purpose. For example, e-mails, and stored digital images may be considered non-real-time data since a time of delivery is not critical. On the other hand, voice data in a telephone conversation and instant messages (IM) may be considered real-time or near-real-time data since a time of delivery is more important.

Transmitter controller 314 may delay transmission of data via network interface 310 by delaying a start time for data transmission. In addition, transmitter controller 314 may delay transmission of data via network interface 310 by pausing or stopping data transmission and restarting data transmission at a later time. As discussed above, transmitter controller 314 may start and restart data transmission based on the same threshold value or based on two different threshold values. Using different threshold values provides the advantage of preventing transmitter components of network interface 310 from cycling on and off rapidly in a case where the power cost per unit data value is rapidly moving above and below a single threshold. Time delays may also be employed for this purpose.

According to another aspect, more than two threshold values may alternatively be employed with each threshold corresponding to a duty cycle for data transmissions via network interface 310. For example, two or more power cost thresholds may be employed with each power cost threshold corresponding to a duty cycle for turning on and off data transmissions via network interface 310. The corresponding duty cycle can decrease (less transmitter-on time) as the power cost thresholds increase. As the power cost per unit data exceeds each power cost threshold, the corresponding duty cycle is used for data transmission via network interface 310. Alternatively, the duty cycle corresponding to the nearest power cost thresholds may be used.

According to another aspect, one or more data transmission policies may be stored in memory 312 and retrieved and applied by processor 308 based on current conditions. For example, processor 308 may determine a data transmission policy based on one or more data transmission-related characteristics, such as a type of data being transmitted, a priority associated with the type of data being transmitted, a priority assigned to data transmission by a user, a communication network type, a type of transmission, a data size being transmitted, a type of application requesting the transmission, a destination of the data transmission, a time of day, a location of the sending device, previous data transmissions, a utility charge for power during a time period or a relative charge for power with respect to one or more later time periods, and remaining battery capacity or available power from a non-battery source. In one implementation, the one or more transmission-related characteristics may be used to select a corresponding data transmission policy from a table stored in memory 312. The data transmission policy may then be used to determine a power cost threshold value. In addition, processor 308 may be configured to dynamically update the threshold as different data transmission policies are applied.

Sending device 106 also includes other device processes 316 associated with the operation of sending device 106. For example, sending device 106 includes data generation components that generate data from various sources, applications 320, a user preference monitor 322 for determining user preferences that may be input via a user interface, and a battery capacity monitor 324 that monitors a battery level for a device that includes a battery. It will be understood that sending device 106 may include many other device processes 316 known in the art.

It should also be understood that device processes 316, network interface 310, memory 312, and receiving device 104 are not necessarily components of the system for controlling data transmission based on power cost, but may be optionally employed as needed. In addition, it should be understood that the various components illustrated in FIG. 3 represent logical components that are configured to perform the functionality described herein and may be implemented in software, hardware, or a combination of the two. Moreover, some or all of these logical components may be combined or may be omitted altogether while still achieving the functionality described herein.

As discussed above, the data transmission policy may be selected based on one or more data transmission-related characteristics. Some or all of the data transmission-related characteristics may be determined by monitoring device processes 316. For example, the type of data being transmitted, a type of transmission, a data size being transmitted, a type of application requesting the transmission, a destination of the data transmission, a time of day, a location of the sending device, previous data transmissions, and a priority associated with the type of data being transmitted may be determined by monitoring applications 320. In one example, an e-mail being sent to a spouse may be given higher priority and thus a higher power cost threshold then an e-mail sent to someone else, as can be dictated by the corresponding data transmission policy. E-mails, in general, may be assigned to one data transmission policy while instant messages and photographs are assigned to other policies.

The priority assigned to data transmission by a user may be determined by monitoring user preference monitor 322. User preference monitor may include a keyboard (or keypad), display, and appropriate user interface. Remaining battery capacity can be determined by monitoring battery capacity monitor 324 when sending device 106 includes a battery.

According to another aspect, processor 308 determines a remaining battery capacity for the sending device 106 from battery capacity monitor 324. Transmitter controller 314 delays transmission of data based on both a determination that the power cost per unit data exceeds the threshold and the remaining battery capacity. In this case, the threshold may be static but may only be applied to control data transmission when the battery capacity is below a power save threshold value. For example, power cost considerations may only come into play when battery levels drop below 25%.

In an example of a device drawing power from a non-battery power source, a power level monitor (not shown) can detect a low power situation and delay transmission possibly averting a power outage, particularly if there are multiple sending devices performing the methods described in this document.

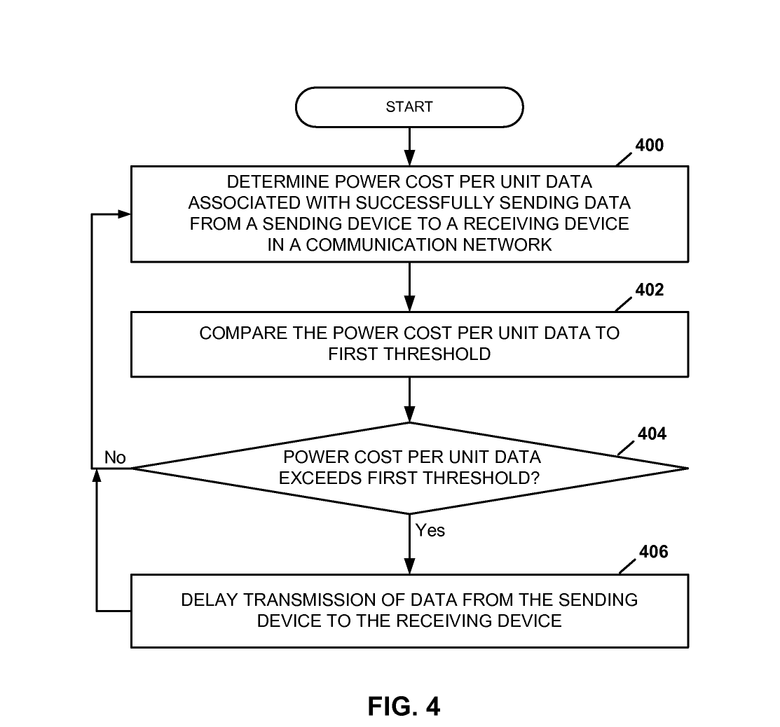

FIG. 4 is a flow diagram illustrating a method for controlling data transmission based on power cost according to an aspect of the subject matter disclosed herein. In block 400, a power cost per unit data associated with successfully sending data from sending device 106 to receiving device 104 is determined by power cost monitor 300. The power cost per unit data is compared to a threshold by processor 308 in block 402. Processor 308 determines whether the power cost per unit data exceeds the threshold in block 404. In block 406, transmitter controller 314 delays transmission of data to receiving device 104 based on processor 308 determining that the power cost per unit data exceeds the threshold in block 404. When processor 308 determines that the power cost per unit data does not exceed the threshold in block 404, control returns to block 400.

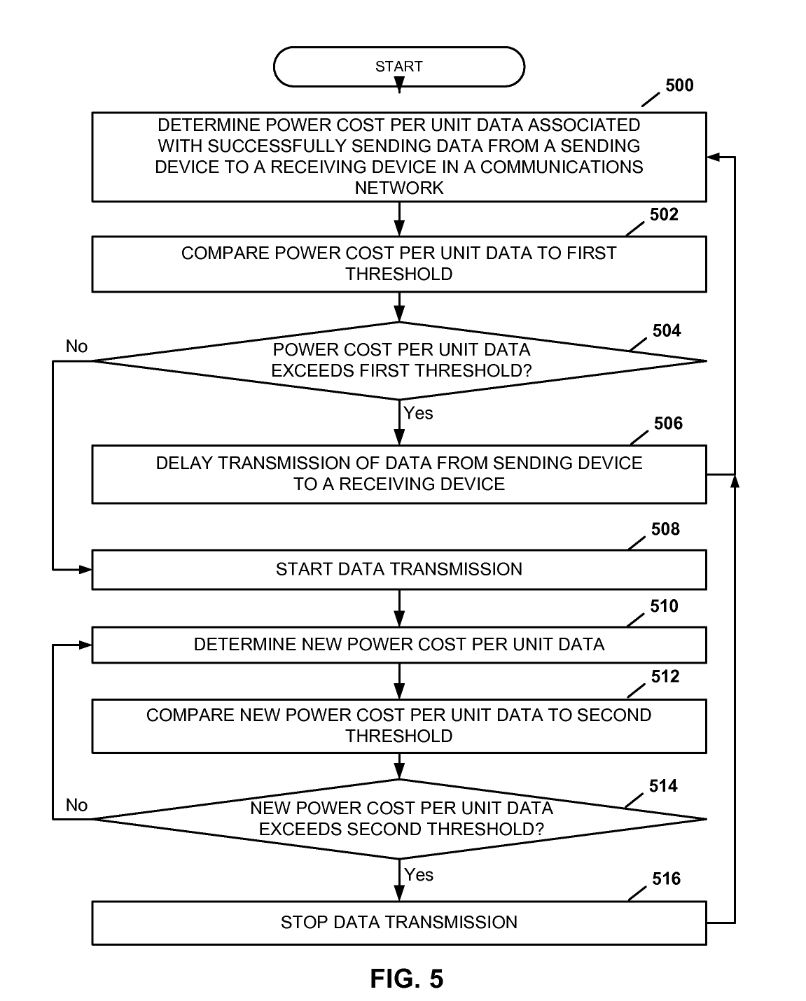

FIG. 5 is a flow diagram illustrating a method for controlling data transmission based on power cost according to another aspect of the subject matter disclosed herein. In block 500, a power cost per unit data associated with successfully sending data from sending device 106 to receiving device 104 is determined by power cost monitor 300. The power cost per unit data is compared to a first threshold by processor 308 in block 502. Processor 308 determines whether the power cost per unit data exceeds the first threshold in block 504. In block 506, transmitter controller 314 delays transmission of data to receiving device 104 based on processor 308 determining that the power cost per unit data exceeds the first threshold in block 504. In response to processor 308 determining that the power cost per unit data does not exceed the first threshold in block 504, data transmission is started in block 508. A new power cost per unit data is determined by power cost monitor 300 in block 510. The new power cost per unit data is compared to a second threshold by processor 308 in block 512. Processor 308 determines whether the new power cost per unit data exceeds the second threshold in block 514. In block 516, transmitter controller 314 stops transmission of data to receiving device 104 based on processor 308 determining that the new power cost per unit data exceeds the second threshold in block 514. In response to processor 308 determining that the new power cost per unit data does not exceed the first threshold in block 514, control returns to block 510.

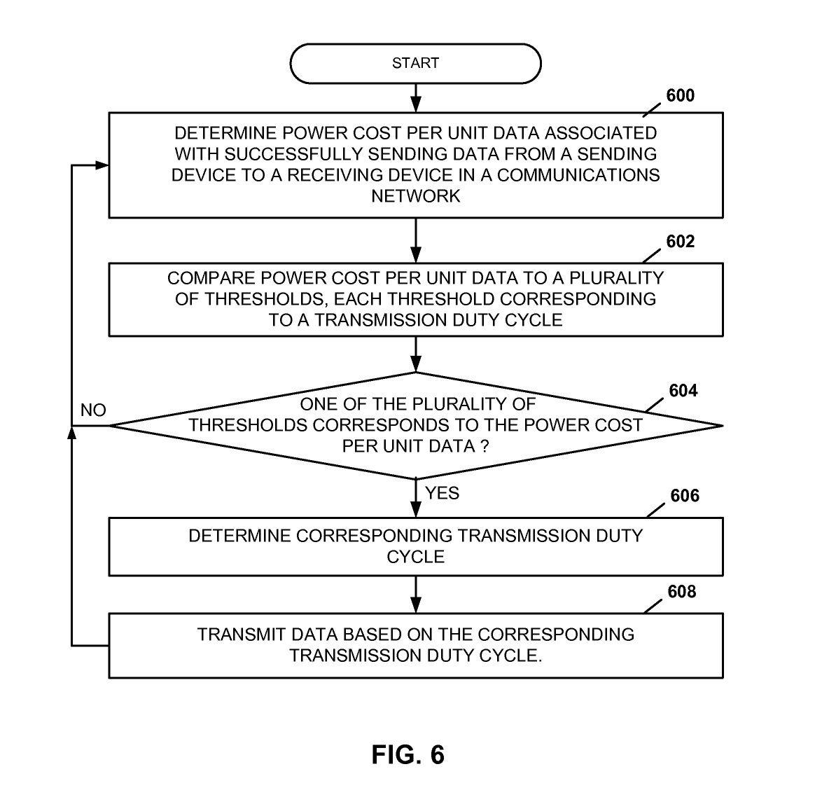

FIG. 6 is a flow diagram illustrating a method for controlling data transmission based on power cost according to another aspect of the subject matter disclosed herein. In block 600, a power cost per unit data associated with successfully sending data from sending device 106 to receiving device 104 is determined by power cost monitor 300. The power cost per unit data is compared to a plurality of thresholds by processor 308 in block 602. Processor 308 determines whether the power cost per unit data corresponds to one of the plurality of thresholds in block 604. For example, the power cost per unit data may correspond to the highest threshold that it exceeds. Alternatively, the power cost per unit data may correspond to the nearest threshold. In block 606, processor 308 determines a transmission duty cycle corresponding to the threshold based on processor 308 determining that the power cost per unit data corresponds to one of the plurality of thresholds in block 604. Data is transmitted based on the corresponding transmission duty cycle in block 608. When processor 308 determines that the power cost per unit data does not correspond to one of the plurality of thresholds in block 604, control returns to block 600.

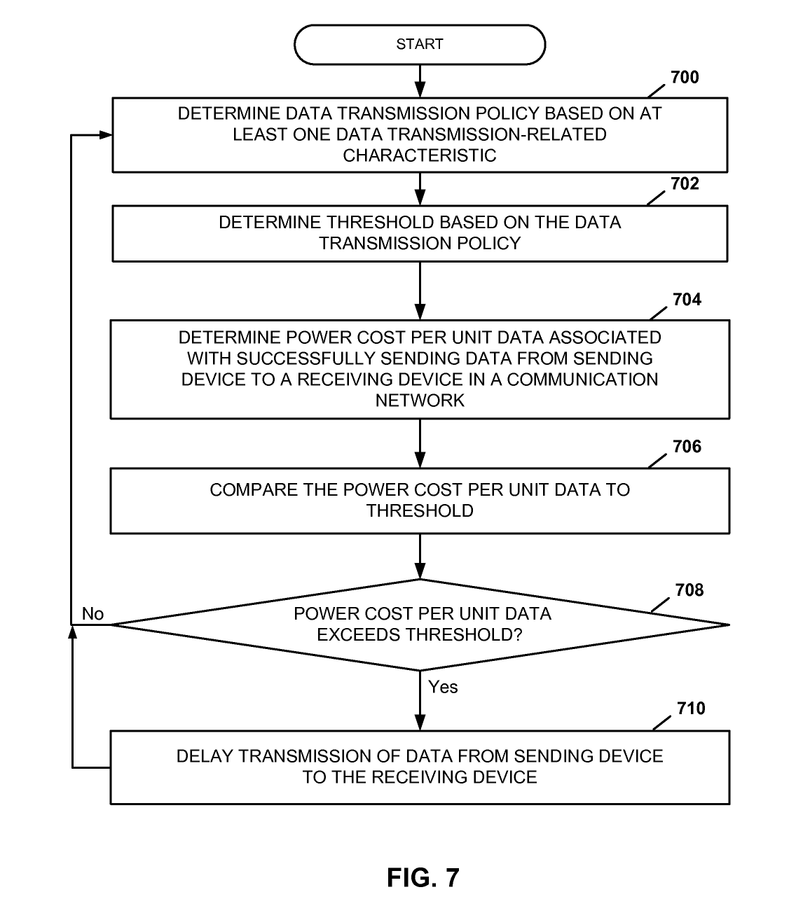

FIG. 7 is a flow diagram illustrating a method for controlling data transmission based on power cost according to another aspect of the subject matter disclosed herein. In block 700, a data transmission policy is determined by processor 308 based on at least one data transmission-related characteristic. A threshold is determined based on the data transmission policy by processor 308 in block 702. Power cost per unit data associated with successfully sending data from sending device 106 to receiving device 104 is determined by power cost monitor 300 in block 704. The power cost per unit data is compared to the threshold by processor 308 in block 706. Processor 308 determines whether the power cost per unit data exceeds the threshold in block 708. In block 710, transmitter controller 314 delays transmission of data to receiving device 104 based on processor 308 determining that the power cost per unit data exceeds the threshold in block 708. When processor 308 determines that the power cost per unit data does not exceed the threshold in block 700, control returns to block 700.

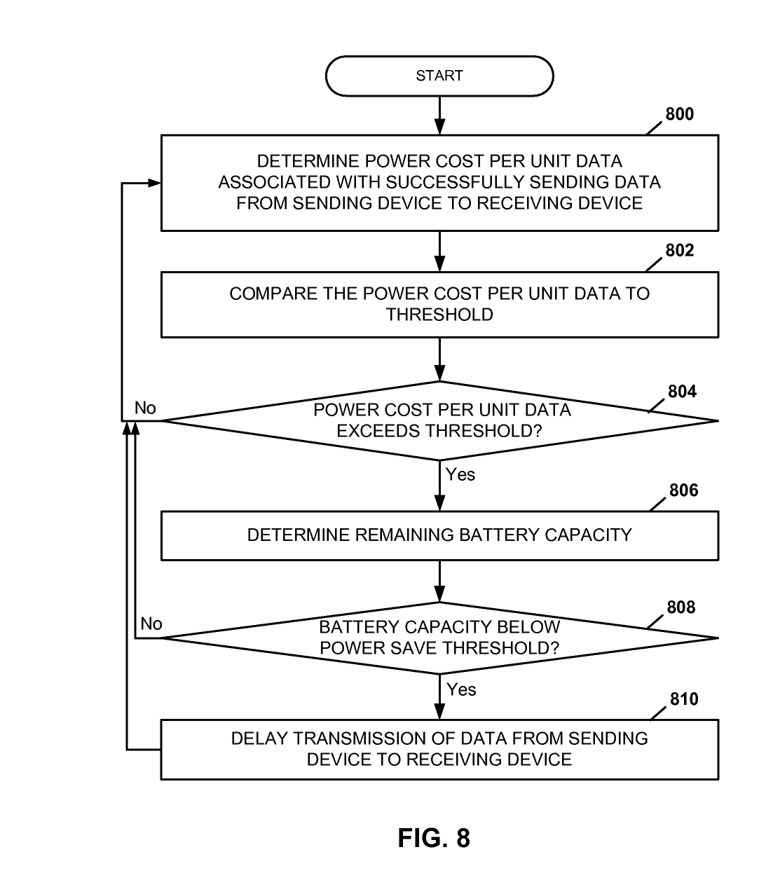

FIG. 8 is a flow diagram illustrating a method for controlling data transmission based on power cost for a device including a battery according to another aspect of the subject matter disclosed herein. In block 800, a power cost per unit data associated with successfully sending data from sending device 106 to receiving device 104 is determined by power cost monitor 300. The power cost per unit data is compared to a threshold by processor 308 in block 802. Processor 308 determines whether the power cost per unit data exceeds the threshold in block 804. When processor 308 determines that the power cost per unit data does not exceed the threshold in block 804, control returns to block 800. In block 806, the remaining battery capacity for sending device 106 is determined by processor 308 from battery capacity monitor 324. In block 808, processor 308 determines whether the battery capacity is below a power save threshold. In response to determining that the battery capacity is below the power save threshold in block 808, transmitter controller 314 delays transmission of data to receiving device 104 in block 810. When processor 308 determines that the battery capacity is not below the power save threshold in block 808, control returns to block 800.

It should be understood that the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), (g), or (n) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter.

Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for controlling data transmission based on power cost, the method comprising:
determining a power cost per unit data associated with successfully sending data from a sending device to a receiving device in a communications network;
comparing the power cost per unit data to a first threshold; and
delaying transmission of data from the sending device to the receiving device based on a determination that the power cost per unit data exceeds the first threshold.

2. The method of claim 1 wherein determining a power cost per unit data associated with successful communications between a sending device and a receiving device in the communications network comprises:
determining a data transmission rate associated with successfully sending data from the sending device to the receiving device;
determining a power consumption rate associated with data transmission; and
determining the power cost per unit data based on the determined data transmission rate and determined power consumption rate.

3. The method of claim 2 wherein determining a data transmission rate associated with successfully sending data from the sending device to the receiving device includes determining at least one of a data throughput, a bit error rate (BER), a number of retries, a number of dropped packets, and a number of collisions.

4. The method of claim 2 wherein determining a data transmission rate associated with successfully sending data from the sending device to the receiving device includes determining a data transmission rate based on a transmission attribute of a network protocol layer.

5. The method of claim 2 wherein the power consumption rate associated with data transmission is determined based on at least one of:
whether a transmitter of the sending device is currently active;
a utility charge for power supplied to the sending device; and
a monitored power level for power supplied to the sending device.

6. The method of claim 2 wherein determining the power cost per unit data based on the determined data transmission rate and determined power consumption rate includes dividing the determined power consumption rate by the determined data transmission rate.

7. The method of claim 1 wherein delaying transmission of data from the sending device to the receiving device includes delaying transmission of only non-real-time data.

8. The method of claim 1 wherein delaying transmission of data from the sending device to the receiving device includes pausing and restarting data transmission.

9. The method of claim 1 wherein the sending device is an intermediate device.

10. The method of claim 1 comprising:
determining a data transmission policy based on at least one data transmission-related characteristic; and
determining the first threshold based on the data transmission policy.

11. The method of claim 10 wherein determining a data transmission policy based on at least one data transmission-related characteristic includes determining the data transmission policy based on at least one of a type of data being transmitted, a priority associated with the type of data being transmitted, a priority assigned to data transmission by a user, a communication network type, a type of transmission, a data size being transmitted, a type of application requesting the transmission, a destination of the data transmission, a time of day, a location of the sending device, previous data transmissions, and remaining battery capacity.

12. A computer program product comprising computer executable instructions embodied in a computer-readable medium for performing steps comprising:
determining a power cost per unit data associated with successfully sending data from a sending device to a receiving device in a communications network;
comparing the power cost per unit data to a first threshold; and
delaying transmission of data from the sending device to the receiving device based on a determination that the power cost per unit data exceeds the first threshold.

13. A system for controlling data transmission based on power cost, the system comprising:
means for determining a power cost per unit data associated with successfully sending data from a sending device to a receiving device in a communications network;
means for comparing the power cost per unit data to a first threshold; and
means for delaying transmission of data from the sending device to the receiving device based on a determination that the power cost per unit data exceeds the first threshold.

14. A system for controlling data transmission based on power cost, the system comprising:
a power cost monitor configured to determine a power cost per unit data associated with successfully sending data from a sending device to a receiving device in a communications network and that compares the power cost per unit data to a first threshold; and
a transmitter controller configured to delay transmission of data from the sending device to the receiving device based on a determination that the power cost per unit data exceeds the first threshold.

15. The system of claim 14 wherein the power cost monitor comprises:
a data rate monitor configured to determine a data transmission rate associated with successfully sending data from the sending device to the receiving device;
a power consumption rate monitor configured to determine a power consumption rate associated with data transmission, wherein the power consumption rate determination takes any unsuccessful data transmissions into account; and
a processor configured to determine the power cost per unit data based on the determined data transmission rate and determined power consumption rate and compares the power cost per unit data to the first threshold.

16. The system of claim 15 wherein the data rate monitor is configured to determine a data transmission rate associated with successfully sending data from the sending device to the receiving device by determining at least one of a data throughput, a bit error rate (BER), a number of dropped packets, a number of retries, and a number of collisions.

17. The system of claim 15 wherein the data rate monitor is configured to determine a data transmission rate associated with successfully sending data from the sending device to the receiving device based on a transmission attribute of a network protocol layer.

18. The system of claim 15 wherein the power consumption rate monitor is configured to determine a power consumption rate associated with data transmission based on at least one of:
whether a transmitter of the sending device is currently active;
a utility charge for power supplied to the sending device; and
a monitored power level for power supplied to the sending device.

19. The system of claim 15 wherein the processor is configured to determine the power cost per unit data based on the determined data transmission rate and determined power consumption rate by dividing the determined power consumption rate by the determined data transmission rate.

20. The system of claim 14 wherein the transmitter controller is configured to delay transmission of data from the sending device to the receiving device by delaying transmission of only non-real-time data.

21. The system of claim 14 wherein the transmitter controller is configured to delay transmission of data from the sending device to the receiving device by pausing and restarting data transmission.

22. The system of claim 14 wherein the sending device is an intermediate device.

23. The system of claim 14 wherein the processor is configured to:
determine a data transmission policy based on at least one data transmission-related characteristic; and
determine the first threshold based on the data transmission policy.

24. The system of claim 23 wherein the processor is configured to determine a data transmission policy based on at least one data transmission-related characteristic by determining the data transmission policy based on at least one of a type of data being transmitted, a priority associated with the type of data being transmitted, a priority assigned to data transmission by a user, a communication network type, a type of transmission, a data size being transmitted, a type of application requesting the transmission, a destination of the data transmission, a time of day, a location of the sending device, previous data transmissions, and remaining battery capacity.
